(19) United States
(12) Patent Application Publication
(10) Pub. No.: US 2015/0377362 A1
(43) Pub. Date: Dec. 31, 2015

(54) Sealed Bearing Assembly

(71) Applicant: APPLIED NANO TECHNOLOGY SCIENCE, INC., Zhudong Township (TW)

(72) Inventors: Jimmean Lin, Zhudong Township (TW); Jamin Shiau, Zhudong Township (TW)

(21) Appl. No.: 14/475,577

(22) Filed: Sep. 3, 2014

(30) Foreign Application Priority Data
Jun. 27, 2014 (TW) 103122377

(51) Int. Cl. F16J 15/43; F16C 33/72

(52) U.S. Cl. CPC F16J 15/43; F16C 33/72

(57) ABSTRACT

A sealed bearing assembly comprises an inner magnetic ring and an external magnetic ring to magnetically attract ferrofluid to block liquids or gases. The sealing can be maintained when a shaft is in a linear movement relative to a shell, and the sealed bearing assembly is under stringent conditions.

### CROSS-REFERENCE TO RELATED APPLICATION

This application claims the benefit of foreign application of TAIWAN Patent Application Serial Number 103122377, filed on Jun. 27, 2014, which are herein incorporated by reference in its integrity.

### TECHNICAL FIELD

The invention is relevant to a bearing assembly, especially a sealed bearing assembly.

### DESCRIPTION OF RELATED ART

To allow the bearing assembly being operated safely and consistently under the required conditions, the bearing assembly requires sealing to prevent leakage of the lubricant within the assembly, and to prevent external dust, moisture, foreign substances, liquids, gases and other substances from entering into the bearing assembly. The assembly of elements for such purpose is the sealed bearing assembly.

With the advancement of technology, the sealed bearing assembly requirements are rising. However, the traditional bearing assembly can not maintain the sealing effect when the shaft moves with respect to the shell in a linear direction.

To sum up, the sealed bearing assembly, which can maintain the sealing when the shaft moves with respect to the shell in linear direction under stringent conditions, is required.

### SUMMARY

The invention aims to resolve the above-mentioned problems.

One embodiment of the invention provides a sealed bearing assembly including a shell; a shaft being movable linearly relative to the shell; a sealing ring fixed to the shaft, and the sealing ring is cylindrical, an axis of the sealing ring is identical to the axis of the shaft; an inner magnetic ring being provided in the sealing ring and being surrounding the shaft; an external magnetic ring being housed inside the shell and being surrounding the inner magnetic ring; and a ferrofluid being attracted by a magnetic force of the external magnetic ring to be distributed on a surface of the shell toward the shaft.

The ferrofluid is composed of magnetic particles, the surfactant molecules, and liquid carrier. Magnetic particles are nanoscale ferromagnetic molecules coated with surfactant molecules, and evenly dispersed in the liquid carrier, like a mass of flowing ferromagnetic material. When affected by magnetic field, the ferrofluid is distributed along the magnetic field lines and forms various shapes. To block a gap, the ferrofluid can be used together with the magnetic field to form the barrier to block both sides of the barrier.

The present invention uses the feature the ferrofluid can be attracted and moved by the magnetic force to achieve the sealing effect not only when the shaft rotates in a rotational direction but also when the shaft moves in a straight line.

Based on the experimental results, the sealed bearing assembly of the present invention is able to maintain a good sealing effect in the following conditions: 1*E-7 torr vacuum, 2 atm pressure difference, 0˜80° C. temperature range, 20 mm shaft diameter, 300 mm linear displacement stroke, 25 mm/sec linear displacement speed, and 200 RPM rotation speed.

### BRIEF DESCRIPTION OF THE DRAWINGS

The primitive objectives and advantages of the present invention will become apparent upon reading the following description and upon reference to the accompanying drawings in which:

FIG. 1A illustrates an appearance of the sealed bearing assembly based on an embodiment of the invention;

FIG. 1B illustrates a cross-section of the sealed bearing assembly based on an embodiment of the invention;

FIG. 2 is an enlarged view of the inner area of FIG. 1B;

FIG. 3 is an enlarged view of the central area of FIG. 2;

FIG. 4 is the perspective view illustrating elements of the invention;

FIG. 5 shows the distribution of the ferrofluid on a surface of the shell toward the shaft when the ring-shaped permanent magnets of the external magnetic ring are arranged with same magnetic poles placed adjacently; and

FIG. 6 shows the distribution of the ferrofluid on a surface of the shell toward the shaft when the ring-shaped permanent magnets of the external magnetic ring are arranged with different magnetic poles placed adjacently.

### DETAILED DESCRIPTION

In order to fully understand the manner in which the above-recited details and other advantages and objects according to the invention are obtained, a more detailed description of the invention will be rendered by reference to the best-contemplated mode and specific embodiments thereof. The following description of the invention is made for the purpose of illustrating the general principles of the invention and should not be taken in a limiting sense; it is intended to illustrate various embodiments of the invention. As such, the specific modifications discussed are not to be construed as limitations on the scope of the invention. It will be apparent to one skilled in the art that various equivalents, changes, and modifications may be made without departing from the scope of the invention, and it is understood that such equivalent embodiments are to be included herein. The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this detailed description section. Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list.

Preferred embodiments and aspects of the invention will be described to explain the scope, structures and procedures of the invention. In addition to the preferred embodiments of the specification, the present invention can be widely applied in other embodiments.

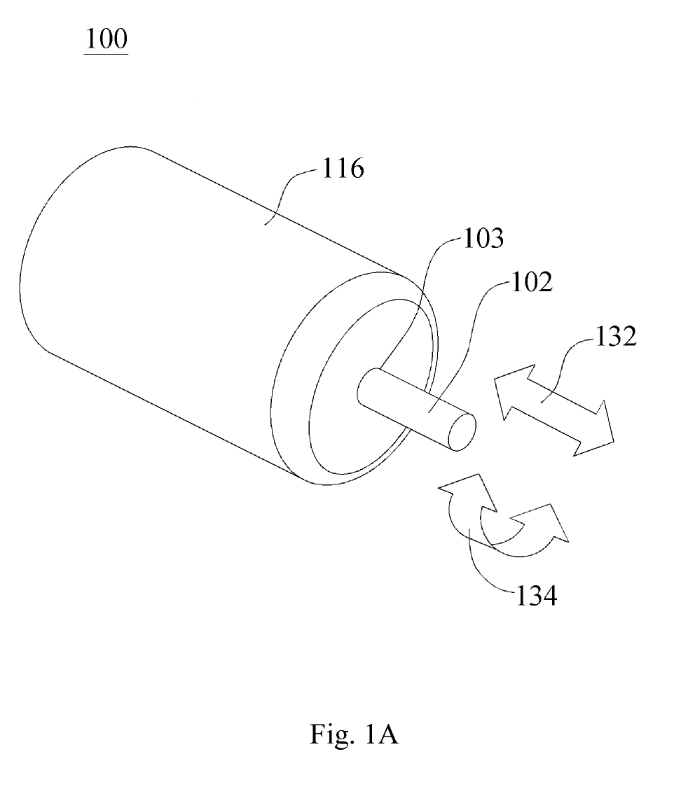

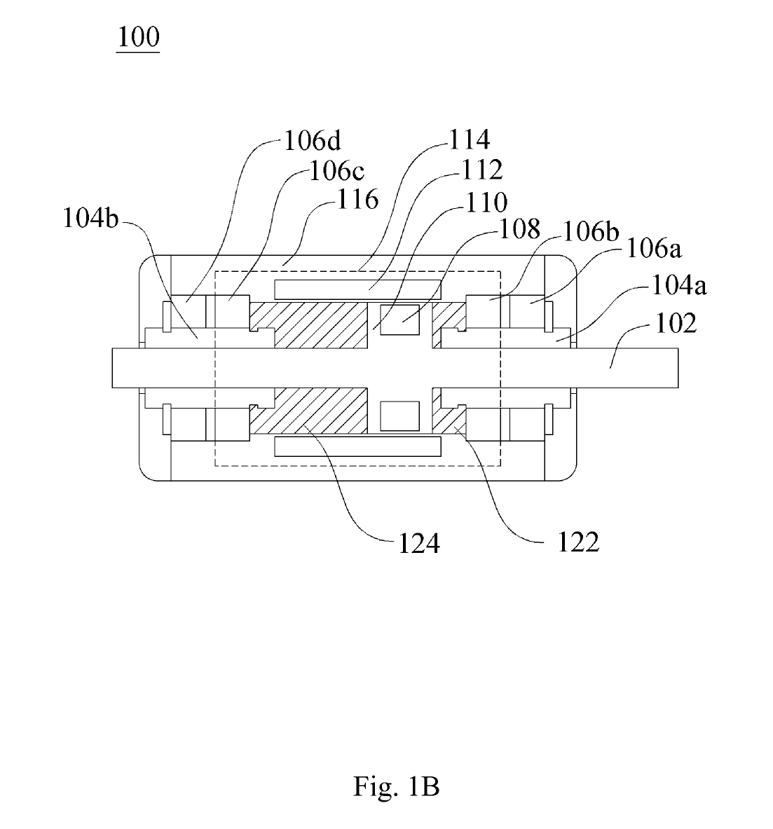

FIG. 1A illustrates an appearance of the sealed bearing assembly 100 based on an embodiment of the invention. A shaft 102, which passes through a shaft hole 103 on the shell 116, can not only rotate in the rotational movement direction 134 as shown, but also move in the linear movement direction 132 as shown while still achieving the sealing effect. In other words, the gas or liquid from the environment may flow through the shaft hole 103 but is stopped by the sealed bearing assembly 100. Thus, the sealed bearing assembly 100 can achieve the sealing effect. The structure of the sealed bearing assembly goes as follows.

FIG. 1B illustrates a cross-section of the sealed bearing assembly 100 based on an embodiment of the invention. The sealed bearing assembly 100 including a sealing ring 110 fixed to the shaft 102, and the sealing ring 110 is cylindrical. The axis of the sealing ring 110 is identical to the axis of the shaft. An inner magnetic ring 108 is provided in the sealing ring 108 and is surrounding the shaft 102. An external magnetic ring 112 is housed inside the shell 116 and is surrounding the inner magnetic ring 108. Further, a ferrofluid (not shown) between the external magnetic ring 112 and the shaft 102 is attracted by a magnetic force of the external magnetic ring 112 to be distributed on a surface of the shell 116 toward the shaft 102.

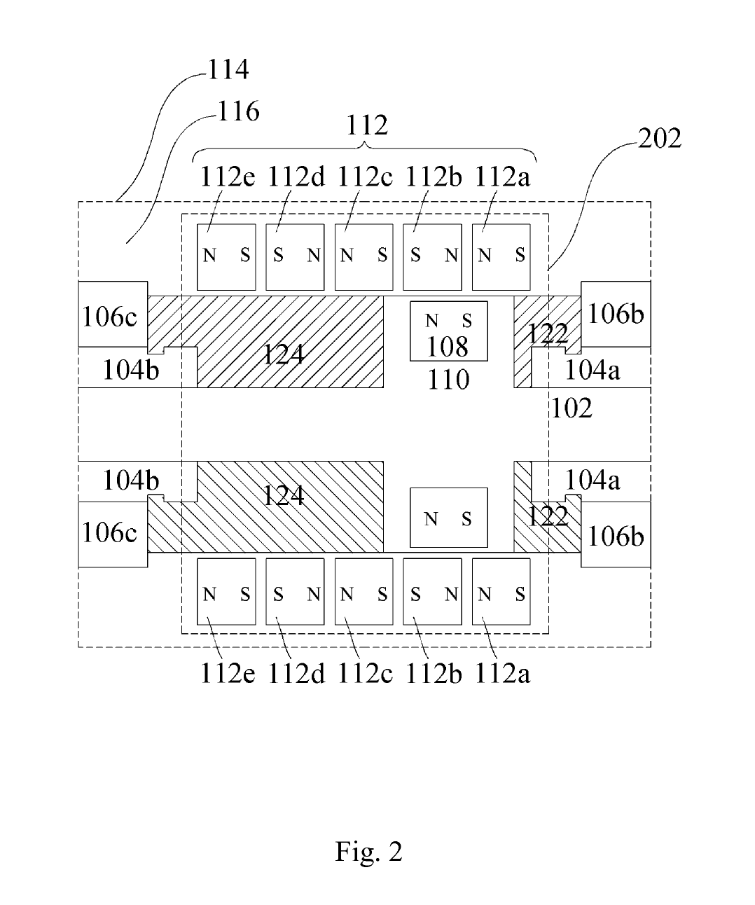

FIG. 2 is an enlarged view of the inner area 114 of FIG. 1B. The external magnetic ring 112 includes ring-shaped permanent magnets 112a-112e, which surround the inner magnetic ring 108.

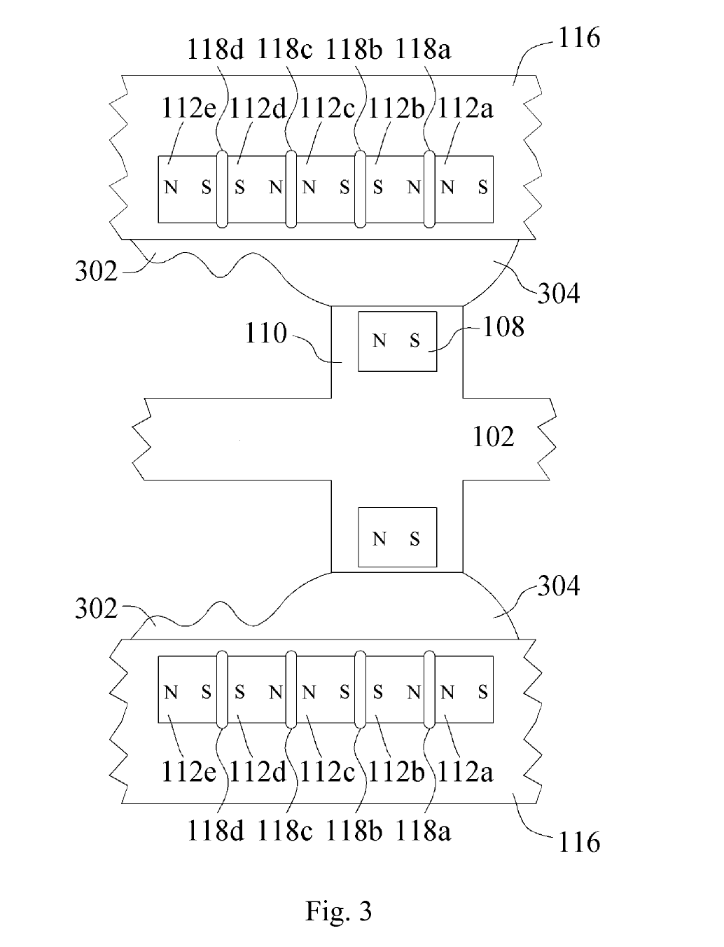

FIG. 3 is an enlarged view of the central area 202 of FIG. 2. A ferrofluid 302 between the external magnetic ring 112 and the shaft 102 is attracted by a magnetic force of the external magnetic ring 112 to be distributed on a surface of the shell 116 toward the shaft 102.

FIG. 3 illustrates that when the inner magnetic ring 108 moves with the sealing ring 110 to a section of the external magnetic ring 112, a magnetic force is generated between the inner magnetic ring 108 and the section of the external magnetic ring 112 to attract the ferrofluid 302 to flow, and thus the ferrofluid 302 forms a shaft seal 304 between the inner magnetic ring 108 and the section of the external magnetic ring 112 by surrounding a periphery of the sealing ring 110 to block gas or liquid in the sealing ring 110. Therefore, the sealing ring 110 can be used as a boundary blocking the flow of gas or liquid in the sealing ring 110.

That is, when the shaft 102 in the linear movement direction 132 shown in FIG. 1A, the sealing ring 110 and the inner magnetic ring 108 also moves linearly, and the linear movement attracts the ferrofluid 302 and the shaft seal 304 formed by the ferrofluid 302 moves together. Thus, the sealing can be maintained for blocking the flow of gas or liquid in the sealing ring 110.

To sum up, based on the property that ferrofluid 302 can be attracted and moved by the magnetic force, the structure of the invention can achieve the sealing effect while the shaft 102 and the sealing ring 110 can not only rotate in the rotational movement direction 134 as shown in FIG. 1A, but also move in the linear movement direction 132 as shown in FIG. 1A.

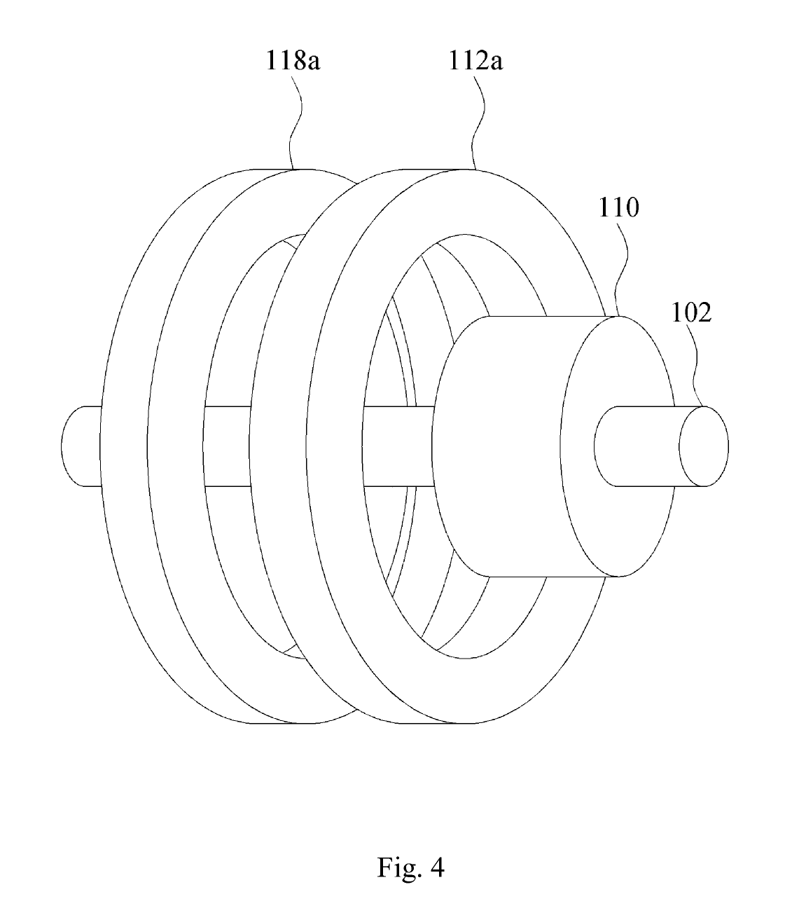

FIG. 4 is the perspective view illustrating elements of the invention. As shown, the shaft 102 and the sealing ring 110 of the present invention are cylindrical, and the ring-shaped permanent magnet 112a and the permeable ring 118a are annular.

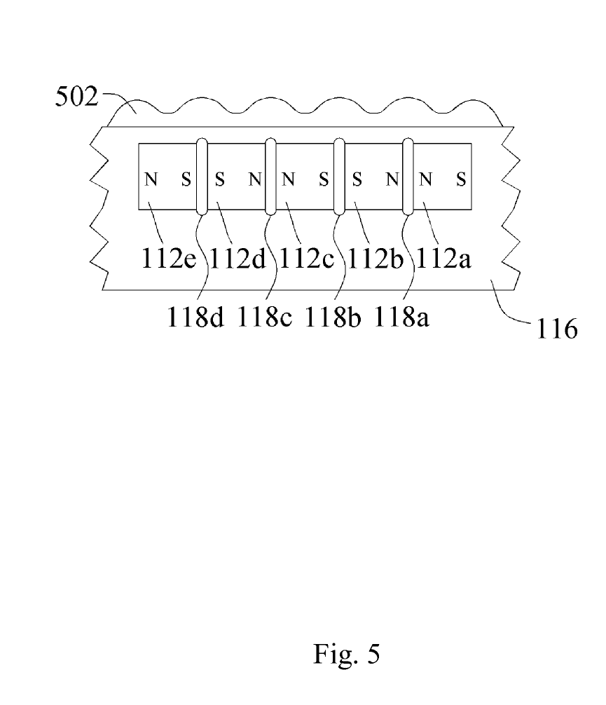

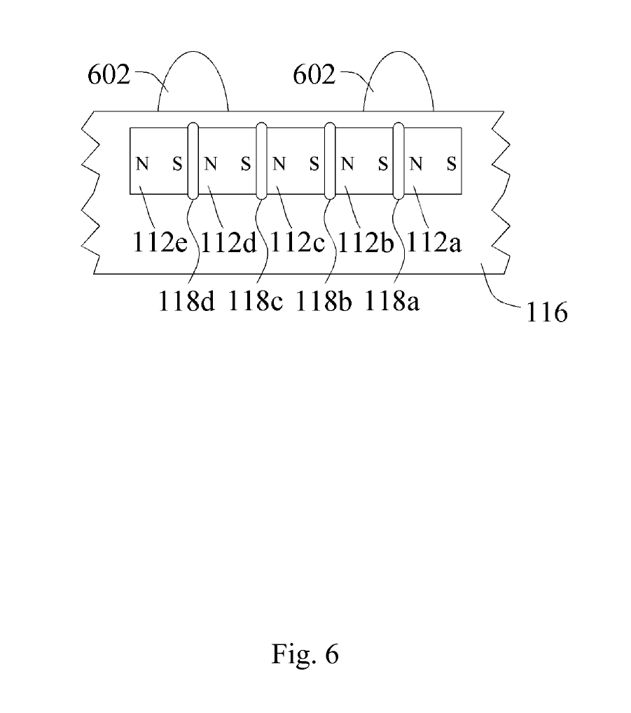

Alternatively, the ring-shaped permanent magnets 112a-112e of the external magnetic ring 112 are arranged with same magnetic poles placed adjacently, as shown in FIG. 2. For example, the N pole of the ring-shaped permanent magnet 112a is adjacent to the N pole of another ring-shaped permanent magnet 112b. The advantages of the arrangement of the magnets with the same magnetic poles placed adjacently will be described hereinafter with reference to FIGS. 5 and 6.

Alternatively, each two of the ring-shaped permanent magnets 112a-112e of the external magnetic ring 112 are separated by one of the permeable rings 118a-118d, which surround the inner magnetic ring 108, shown in FIG. 3.

FIG. 1B illustrates another embodiment of the invention, where the sealed bearing assembly 100 further comprises two linear bearings 104a, 104b, whose centers are passed by the shaft 102 to hold and support the shaft 102. Further, the sealed bearing assembly of the invention can further comprise bearings 106a-106b, which hold the two linear bearings 104a, 104b.

Alternatively, the external magnetic ring 112 can be a permanent magnet or an electrical magnet. That is, the external magnetic ring 112 may be an electromagnetic coil controlled by the current to produce the electromagnetic induction, and the magnetic force. Similarly, the inner magnetic ring 108 can be a permanent magnet or an electrical magnet. That is, the inner magnetic ring 108 may be an electromagnetic coil controlled by the current to produce the electromagnetic induction, and the magnetic force.

FIG. 5 shows the distribution of the ferrofluid 502 on a surface of the shell 116 toward the shaft when the ring-shaped permanent magnets 112a-112e of the external magnetic ring are arranged with same magnetic poles placed adjacently. The experiments prove that when the sealing ring 110 and the inner magnetic ring 108 are not close to the ring-shaped permanent magnets 112a-112e, the magnetic field generated by the ring-shaped permanent magnets 112a-112e makes ferrofluid 502 evenly distributed in wavy shape on the surface of the shell 116 toward the shaft 102 because the ring-shaped permanent magnets 112a-112e of the external magnetic ring are arranged with same magnetic poles placed adjacently. While the sealing ring 110 and the inner magnetic ring 108 get close to the ring-shaped permanent magnets 112a-112e, the resulted effect will make the magnetic circuits connected in part and result in the shaft seal 304 shown in FIG. 3, which can achieve the sealing effect. Therefore, the arrangement of the ring-shaped permanent magnets 112a-112e with the same magnetic poles placed adjacently is suitable for the invention.

FIG. 6 shows the distribution of the ferrofluid 602 on a surface of the shell 116 toward the shaft when the ring-shaped permanent magnets 112a-112e of the external magnetic ring are arranged with different magnetic poles placed adjacently. The experiments prove that when the sealing ring 110 and the inner magnetic ring 108 are not close to the ring-shaped permanent magnets 112a-112e, the magnetic field generated by the ring-shaped permanent magnets 112a-112e makes ferrofluid 502 centralized two ends of the surface of the shell 116 toward the shaft 102 because the ring-shaped permanent magnets 112a-112e of the external magnetic ring are arranged with different magnetic poles placed adjacently. While the sealing ring 110 and the inner magnetic ring 108 get close to the ring-shaped permanent magnets 112a-112e, the resulted effect cannot make the magnetic circuits connected in part and thus cannot result in the shaft seal 304 shown in FIG. 3, which can achieve the sealing effect. Therefore, the arrangement of the ring-shaped permanent magnets 112a-112e with the different magnetic poles placed adjacently is not suitable for the invention.

The foregoing description, for purposes of explanation, was set forth in specific details of the preferred embodiments to provide a thorough understanding of the invention. However, it will be apparent to one skilled in the art that specific details are not required in order to practice the invention. Therefore, the foregoing descriptions of specific embodiments of the invention are presented for purposes of illustration and description only and should not be construed in any way to limit the scope of the invention. They are not intended to be exhaustive or to limit the invention to the precise forms disclosed; obviously, many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following Claims and their equivalents define the scope of the invention.

The above-described embodiments of the present invention are intended to be illustrative only. Numerous alternative embodiments may be devised by those skilled in the art without departing from the scope of the following claims.

What is claimed is:

1. A sealed bearing assembly including:
a shell;
a shaft being movable linearly relative to the shell;
a sealing ring fixed to the shaft, and the sealing ring is cylindrical, an axis of the sealing ring is identical to the axis of the shaft;
an inner magnetic ring being provided in the sealing ring and being surrounding the shaft;
an external magnetic ring being housed inside the shell and being surrounding the inner magnetic ring; and
a ferrofluid being attracted by a magnetic force of the external magnetic ring to be distributed on a surface of the shell toward the shaft.

2. The sealed bearing assembly of claim 1, wherein when the inner magnetic ring moves with the sealing ring to a section of the external magnetic ring, a magnetic force is generated between the inner magnetic ring and the section of the external magnetic ring to attract the ferrofluid to flow, and thus the ferrofluid forms a shaft seal between the inner magnetic ring and the section of the external magnetic ring by surrounding a periphery of the sealing ring to block gas or liquid in the sealing ring.

3. The sealed bearing assembly of claim 1, wherein the external magnetic ring includes ring-shaped permanent magnets, which surround the inner magnetic ring.

4. The sealed bearing assembly of claim 3, wherein the ring-shaped permanent magnets of the external magnetic ring are arranged with same magnetic poles placed adjacently.

5. The sealed bearing assembly of claim 3, wherein each two of the ring-shaped permanent magnets of the external magnetic ring are separated by a permeable ring, which surrounds the inner magnetic ring.

6. The sealed bearing assembly of claim 1, further comprising two linear bearings, whose centers are passed by the shaft to hold and support the shaft.

7. The sealed bearing assembly of claim 6, further comprising bearings, which hold the two linear bearings.

8. The sealed bearing assembly of claim 1, wherein the external magnetic ring is an electrical magnet.

9. The sealed bearing assembly of claim 1, wherein the inner magnetic ring is a permanent magnet.

10. The sealed bearing assembly of claim 1, wherein the inner magnetic ring is an electrical magnet.
